(19) United States
(12) Patent Application Publication
(10) Pub. No.: US 2026/0223098 A1
(43) Pub. Date: Jul. 30, 2026

(54) CONFIGURED GRANT OPERATION

(71) Applicant: Nokia Technologies Oy, Espoo (FI)

(72) Inventors: Margarita GAPEYENKO, Espoo (FI); Chunli WU, Beijing (CN); Benoist Pierre SEBIRE, Tokyo (JP); Jorma Johannes KAIKKONEN, Oulu (FI)

(21) Appl. No.: 19/147,533

(22) PCT Filed: Feb. 10, 2023
(86) PCT No.: PCT/CN2023/075495

§ 371 Date: Jul. 11, 2025

(51) Int. Cl. H04W 72/115; H04W 72/1263

(52) U.S. Cl. CPC H04W 72/115; H04W 72/1263

(57) ABSTRACT

Embodiments of the present disclosure relate to CG operation. In one aspect, a first device receives, from a second device, a first CG configuration and a second CG configuration. The first CG configuration is associated with the second CG configuration. If the first device determines that a set of occasions associated with the first CG configuration is to be deactivated for a period of time, the first device activates the second CG configuration. In this way, fast re-activation of a CG configuration may be achieved, and communication latency may be reduced.

### FIELD

Various example embodiments relate to the field of telecommunication and in particular, to a method, device, apparatus and computer readable storage medium of communication for configured grant (CG) operation.

### BACKGROUND

In some scenarios such as an extended reality (XR) traffic model, multiple CG configurations may be needed for various traffic types. If CG resources associated with the CG configurations collide with each other, only one CG configuration may be used for transmission, and other CG configurations may be indicated to be not needed. If a user indicates to cancel certain CG occasions and traffic associated, no valid CG resources will be used for transmission of the traffic.

### SUMMARY

In general, example embodiments of the present disclosure provide a solution of communication for CG operation.

In a first aspect, there is provided a first device. The first device comprises at least one processor; and at least one memory storing instructions that, when executed by the at least one processor, cause the first device at least to: receive, from a second device, a first CG configuration and a second CG configuration, the first CG configuration being associated with the second CG configuration; determine that a set of occasions associated with the first CG configuration is to be deactivated for a period of time; and activate the second CG configuration.

In a second aspect, there is provided a second device. The second device comprises at least one processor; and at least one memory storing instructions that, when executed by the at least one processor, cause the second device at least to: transmit, to a first device, a first CG configuration and a second CG configuration, the first CG configuration being associated with the second CG configuration; determine that a set of occasions associated with the first CG configuration is to be deactivated for a period of time; and activate the second CG configuration.

In a third aspect, there is provided a method for communication. The method comprises: receiving, at a first device and from a second device, a first CG configuration and a second CG configuration, the first CG configuration being associated with the second CG configuration; determining that a set of occasions associated with the first CG configuration is to be deactivated for a period of time; and activating the second CG configuration.

In a fourth aspect, there is provided a method for communication. The method comprises: transmitting, at a second device and to a first device, a first CG configuration and a second CG configuration, the first CG configuration being associated with the second CG configuration; determining that a set of occasions associated with the first CG configuration is to be deactivated for a period of time; and activating the second CG configuration.

In a fifth aspect, there is provided an apparatus for communication. The apparatus comprises: means for receiving, at a first device and from a second device, a first CG configuration and a second CG configuration, the first CG configuration being associated with the second CG configuration; means for determining that a set of occasions associated with the first CG configuration is to be deactivated for a period of time; and means for activating the second CG configuration.

In a sixth aspect, there is provided an apparatus for communication. The apparatus comprises: means for transmitting, at a second device and to a first device, a first CG configuration and a second CG configuration, the first CG configuration being associated with the second CG configuration; means for determining that a set of occasions associated with the first CG configuration is to be deactivated for a period of time; and means for activating the second CG configuration.

In a seventh aspect, there is provided a non-transitory computer readable medium comprising program instructions that, when executed by an apparatus, cause the apparatus to perform at least the method according to the third or fourth aspect.

In an eighth aspect, there is provided a computer program comprising instructions, which, when executed by an apparatus, cause the apparatus to perform at least the method according to the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which embodiments of the present disclosure may be implemented;

FIG. 2A illustrates a diagram illustrating an example scenario of collision of CG configurations in which embodiments of the present disclosure may be implemented;

FIG. 2B illustrates a diagram illustrating an example scenario of traffic transmission with one CG configuration under the collision of CG configurations in which embodiments of the present disclosure may be implemented;

FIG. 3 illustrates a diagram illustrating a process of communication for CG operation according to some embodiments of the present disclosure;

FIG. 4 illustrates a flowchart of an example method implemented at a first device according to some embodiments of the present disclosure;

FIG. 5 illustrates a flowchart of an example method implemented at a second device according to some embodiments of the present disclosure;

FIG. 6 illustrates a simplified block diagram of a device that is suitable for implementing embodiments of the present disclosure; and

FIG. 7 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) next generation NodeB (also referred to as a gNB), a Remote Radio Unit (RRU), a radio header (RH), a remote radio head (RRH), a relay, a low power node such as a femto, a pico, and so forth, depending on the applied terminology and technology. An RAN split architecture comprises a gNB-CU (Centralized unit, hosting RRC, SDAP and PDCP) controlling a plurality of gNB-DUs (Distributed unit, hosting RLC, MAC and PHY).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

XR refers to all real-and-virtual combined environments and associated human-machine interactions generated by computer technology and wearables. XR includes representative forms such as augmented reality (AR), mixed reality (MR), and virtual reality (VR) and the areas interpolated among them. The main XR related video traffic characteristics in uplink (UL) may be summarized as follows: a non-integer periodicity (e.g., 16.6 ms for 60 fps); a packet delay budget (PDB) requirement of 30 ms as baseline and 10 ms and 15 ms as optional; a varying video frame size with mean 20.8 kBytes for 60 fps and 10 Mbit/s following Truncated Gaussian distribution. In addition to video in UL, pose or control information can be sent with the following main characteristics: a periodicity of 4 ms; a stringent PDB requirement of 10 ms; a frame size of 100 bytes.

Recently, it has been proposed to work on capacity enhancements, such as multiple CG physical uplink shared channel (PUSCH) transmission occasions in a period of a single CG PUSCH configuration, and dynamic indication of unused CG PUSCH occasions based on uplink control information (UCI) by user equipment (UE).

As known, scheduling in UL can be realized by employing CG. For CG based scheduling, parameters are configured via a radio resource control (RRC) message. The actual UL grant may either be configured via RRC (type1) or provided via a physical downlink control channel (PDCCH), e.g., addressed to configured scheduling-radio network temporary identifier (CS-RNTI) (type2). The main characteristics of new radio (NR) Release 16 UL CG are: UL radio resources for sending one transport block (TB) with a regular time-periodicity is configured for UE; periodicities are: 2, 7, n*14 symbols, where the range for n depends on configured subcarrier spacing (SCS); up to 12 CG configurations per bandwidth part (BWP) (configured through RRC signaling).

CG enhancements are motivated by a large and variable video size in UL that in many cases require more than one slot to be transmitted. For certain XR applications such as AR, there could be different traffic in UL: (i) pose or control every 4 ms and (ii) video every 16.67 ms for 60 fps. The PDB for pose or control is equal to 10 ms and the PDB for UL video is 30 ms and optional is 10 ms or 15 ms. It is highly possible to support that pose or control in UL could be transmitted with CG resources to satisfy the requirements in terms of PDB.

Whenever there is video and pose transmitted in UL, different CG configurations may be needed: CG configuration 1 for video with periodicity close to video periodicity and large TB size, or with multiple CG occasions per period; CG configuration 2 for pose every e.g., 4 ms with small TB size (e.g., 100 bytes).

As mentioned above, if CG resources associated with the CG configurations collide with each other, only one CG configuration may be used for transmission, and other CG configurations may be indicated to be not needed. If a user indicates to cancel certain CG occasions and traffic associated, no valid CG resources will be used for transmission of the traffic.

In view of this, embodiments of the present disclosure provide a solution of communication for CG operation to overcome the above and other potential issues. In the solution, CG configurations may be associated with each other. If a set of occasions associated with one of the CG configurations is deactivated for a period of time, other CG configurations may be assumed to be activated for the period of time. If one of the CG configurations is used, other CG configurations may be assumed to be deactivated.

In other words, when two or more CG configurations collide and only one CG configuration is chosen to transmit data, other CG configuration(s) can be disabled for N slots while the collision continues. In case a network device received, from a terminal device, an indication to deactivate certain occasion(s) of chosen CG configuration that used to carry data of previously deactivated (e.g., due to the collision) CG configurations, the network device and the terminal device will consider the indication as a trigger to re-activate the previously deactivated CG configuration(s).

In this way, a CG configuration may be implicitly activated or deactivated based on use of at least one of other CG configurations by a terminal device. Accordingly, fast re-activation of a CG configuration may be achieved, and communication latency may be reduced.

Principles and implementations of the present disclosure will be described in detail below with reference to the figures.

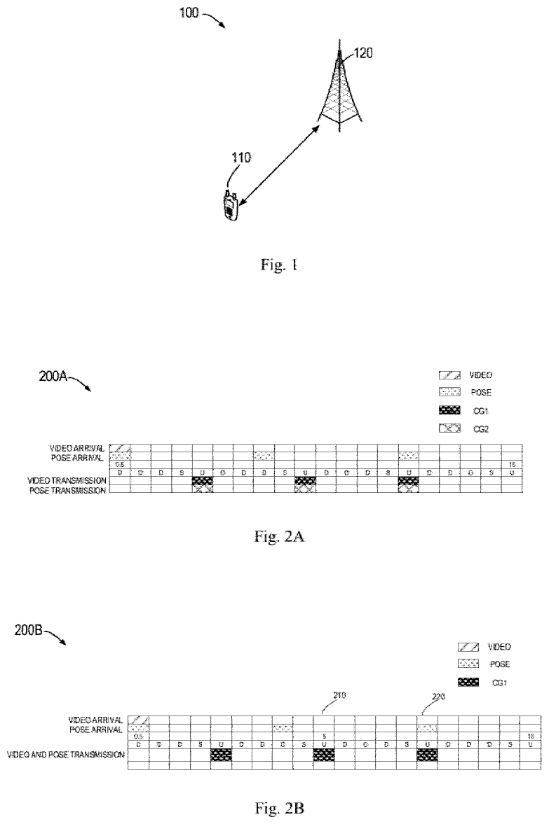

FIG. 1 illustrates a schematic diagram of an example communication environment 100 in which some embodiments of the present disclosure can be implemented. As shown in FIG. 1, the communication environment 100 may include a first device 110 and a second device 120 serving the first device 110. For illustration, the first device 110 is shown as a terminal device and the second device 120 is shown as a network device.

It is to be understood that the number of first and second devices in FIG. 1 is given for the purpose of illustration without suggesting any limitations to the present disclosure. The communication environment 100 may include any suitable number of first devices and/or second devices adapted for implementing implementations of the present disclosure.

Merely for illustration purposes and without suggesting any limitations as to the scope of the present disclosure, some embodiments will be described in the context where the first device 110 is a terminal device and the second device 120 is a network device. It is to be understood that, in other embodiments, the first device 110 may be a network device and the second device 120 may be a terminal device. In other words, the principles and spirit of the present disclosure may be applied to both uplink and downlink transmissions.

As shown in FIG. 1, the first device 110 and the second device 120 may communicate with each other via a wireless communication channel. The communications within the communication environment 100 may conform to any suitable standard including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) or the sixth generation (6G) communication protocols.

In some embodiments, the second device 120 may transmit one or more CG configurations to the first device 110. The one or more CG configurations may be activated or deactivated for traffic transmission. One CG configuration may be associated with one or more traffic.

In some scenarios, CG configurations may collide with each other and only one CG configuration is used for transmission. One straightforward possibility is to choose a CG configuration with a larger TB size to carry the collided traffic such as video and pose. The collision may continue for N consecutive slots where other CG configurations will not be needed. FIG. 2A illustrates a diagram 200A illustrating an example scenario of collision of CG configurations in which embodiments of the present disclosure may be implemented. In this example, it is assumed that a time division duplexing (TDD) structure is DDDSU, and that pose arrivals every 4 ms and video frame arrivals every 16.67 ms. As shown in FIG. 2A, pose and video arrival. CG1 is configured for video transmission and CG2 is configured for pose transmission. CG1 and CG2 in some UL slots collide with each other.

Since a network device knows the number (denoted as N) of consecutive slots for CG1, the network device may deactivate the CG2 resources for the N consecutive slots. FIG. 2B illustrates a diagram 200B illustrating an example scenario of traffic transmission with one CG configuration (e.g., CG1) under the collision of CG configurations in which embodiments of the present disclosure may be implemented. In this example, it is assumed that a TDD structure is DDDSU, and SCS=30 kHz. As shown in FIG. 2B, CG1 and CG2 collide with each other. Upon arrival of pose and video, pose and video are transmitted via CG1, and CG2 is deactivated for 3 UL slots.

However, the video frames in UL may have a variable size and thus predicting the exact number of resources or slots needed is impossible. Thus, it is agreed to specify a dynamic indication of unused CG PUSCH occasions. The key benefit of the dynamic indication is to enable reallocation of unused UL resources. That is, a terminal device may indicate that certain occasion or occasions are not needed and a network device may consider these resources for other users. For example, the terminal device may transmit, in an UL slot 210 in FIG. 2B, UCI indicating that an UL slot 220 is not needed. In this case, the next pose will not have a valid CG resource as CG2 is implicitly disabled for 3 slots in the example.

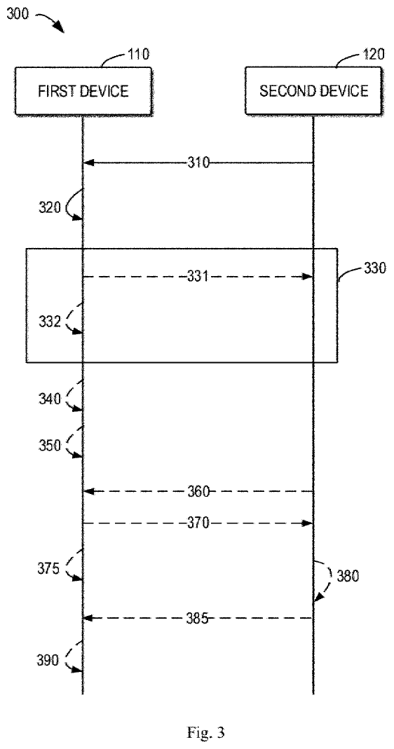

Thus, embodiments of the present disclosure provide a solution of communication for CG operation. More details will be described below in connection with FIG. 3.

FIG. 3 illustrates a flowchart illustrating a diagram illustrating a process 300 of communication for CG operation according to some embodiments of the present disclosure. For the purpose of discussion, the process 300 will be described with reference to FIG. 1. The process 300 may involve the first device 110 and the second device 120 as illustrated in FIG. 1. It is assumed that the first device 110 is served by the second device 120.

As shown in FIG. 3, the second device 120 may transmit 310, to the first device 110, a first CG configuration and a second CG configuration. The first CG configuration is associated with the second CG configuration. In other words, the first and second CG configurations are linked or paired. It is to be understood that the present disclosure does not limit the number of the first and second CG configurations. In other words, the second device 120 may transmit multiple CG configurations, and the multiple CG configurations may be linked or paired. For convenience, the following description is given by taking the first and second CG configurations as an example.

In some embodiments, the first CG configuration may be associated with first traffic or may be associated with both the first traffic and second traffic. That is, the first CG configuration may be used for the first traffic or both the first and second traffic. The second CG configuration may be associated with the second traffic. That is, the second CG configuration may be used for the second traffic. It is to be understood that each of the first and second CG configurations may be associated with more traffic or any traffic, and the present disclosure does not limit the number and type of traffic.

In some embodiments, the first CG configuration may be overlapped with the second CG configuration. For example, the first CG configuration may be fully overlapped with the second CG configuration. In another example, the first CG configuration may be partially overlapped with the second CG configuration. Alternatively, the first CG configuration may not be overlapped with the second CG configuration.

Continue to refer to FIG. 3, the first device 110 may determine 320 that a set of occasions associated with the first CG configuration is to be deactivated for a period of time. In some embodiments, the set of occasions may be all the occasions associated with the first CG configuration. In some embodiments, the set of occasions may be part of the occasions associated with the first CG configuration. In some embodiments, the period of time may be any suitable number of consecutive slots. It is to be understood that any other suitable time units are also feasible.

In some embodiments where the first CG configuration is associated with the first traffic and the second CG configuration is associated with the second traffic, if the first and second CG configurations are overlapped, the first device 110 may determine that a set of occasions carrying the first and second traffic during an overlapped period of the first and second CG configurations is to be deactivated.

In some embodiments where the first CG configuration is associated with the first traffic and the second CG configuration is associated with the second traffic, if a size of a buffer associated with the first traffic is below a first threshold size, the first device 110 may determine that the set of occasions associated with the first CG configuration is to be deactivated.

For example, the first device 110 is configured with two CG configurations: CG #1 dimensioned for UL video frames, and CG #2 dimensioned for UL pose information. The first device 110 may use CG #1 to transmit the UL data related to UL video frame and any other additional data. When the first device 110 has completed the video frame transmission and there is no more related data in UL buffer (e.g., the size of the buffer is below the first threshold size), the first device 110 may deactivate CG #1 and use CG #2 to transmit e.g. UL pose information.

This results that CG #1 is assumed to be implicitly unused for N slots (where N is configurable), or when video data becomes available for transmission. In some embodiments, the second device 120 may know that CG #1 is being used based on UCI indication. In some embodiments, the second device 120 may know that CG #1 is being used based on a timing of the CG #1 configuration. For example, the first occasion of a period is always assumed to be used when there are multiple occasions per configured period. In another example, multiple (e.g., configurable) CG #2 based transmissions are needed to result in implicit disabling of CG #1.

In some embodiments, CG configurations may be associated with a certain UL buffer status, and implicit disabling or enabling of a CG configuration may be based on the content of a buffer status report (BSR). In some embodiments, if a buffer status of a logic channel group (LCG) associated with the first CG configuration in a BSR is below a threshold status, the first device 110 may determine that the set of occasions associated with the first CG configuration is to be deactivated. For example, when the first device 110 reports a BSR and the reported buffer status of the LCG containing a logic channel (LCH) allowed to make use of a CG (e.g., as per allowedCG-List) is lower than a configured threshold (e.g., the threshold status), certain (e.g., larger UL data rate) CG configurations are assumed to be implicitly disabled and other (e.g., smaller UL data rate) CG configurations are assumed to be enabled.

Alternatively or additionally, if a buffer size reported in the BSR is above a second threshold size and the first CG configuration corresponds to a data rate lower than a threshold rate, the first device 110 may determine that the set of occasions associated with the first CG configuration is to be deactivated. For example, when the buffer size reported in the BSR exceeds certain configured threshold (e.g., the second threshold size), certain (e.g., smaller UL data rate) CG configurations are assumed to be implicitly disabled and other (e.g., larger UL data rate) CG configurations are assumed to be enabled. In another example, if the buffer size reported in the BSR exceeds or be lower than the configured threshold for a given time, implicit activation may be resulted.

Continue to refer to FIG. 3, based on the deactivating of the set of occasions associated with the first CG configuration, the first device 110 may activate 330 the second CG configuration. In some embodiments, the first device 110 may transmit 331, to the second device 120, an indication that the set of occasions is to be deactivated for the period of time. In other words, the first device 110 dynamically indicates that certain CG resources are unused. In this case, the first device 110 may activate 332 the linked or paired CG configurations (e.g., the second CG configuration).

In some embodiments, if the first CG configuration is deactivated, the first device 110 may activate the second CG configuration. In some embodiments where the first CG configuration is associated with the first traffic, if no retransmission is scheduled for the first traffic associated with the first CG configuration during the period of time, the first device 110 may activate the second CG configuration. For example, the first device 110 is configured with two CG configurations: CG #1 dimensioned for UL video frames, and CG #2 dimensioned for UL pose information. If no retransmission being scheduled for PUSCH that carried UL video during time X or via PDCCH based activation indication, the first device 110 may activate CG #2 for anticipated UL pose information transmission.

In some embodiments, if the first CG configuration overlapping with the second CG configuration is re-activated, the first device 110 may use the first CG configuration for transmission, and deactivate the second CG configuration for the overlapped period of the first and second CG configurations. For example, the first device 110 is configured with two CG configurations: CG #1 dimensioned for UL video frames, and CG #2 dimensioned for UL pose information. If CG #1 that is overlapping with CG #2 is re-activated (e.g., due to re-transmissions), CG #2 is not activated and CG #1 is transmitting both pose and video for the overlapped period.

Continue to refer to FIG. 3, the first device 110 may determine 340 that the first CG configuration is used for transmission.

In some embodiments, if the first CG configuration has a priority higher than a priority of the second CG configuration, the first device 110 may determine that the first CG configuration is used for transmission. For example, it may be configured which one of the linked CG configurations is prioritized and only one of the linked CG configurations will be used when the CG occasions collide or within a duration (e.g., they are considered as associated ones). The first device 110 may select the prioritized CG configuration to build the TB when there is data transmission for the prioritized CG configuration and indicate the usage of the CG occasion or occasions. Alternatively, the first occasion within a period of the high priority CG configuration is always used when there are multiple occasions per period. For the associated occasions, the deprioritized CG configuration is automatically activated or used where a CG occasion of the prioritized CG configuration is used, and vise versa. Based on the indication, the second device 110 may know whether the prioritized or the deprioritized CG configuration is used, and thus may allocate the unused resource to other devices. In this case, only one indication is needed for the linked CG configurations, and thus no explicit indication is needed for the deprioritized CG configuration.

In some alternative or additional embodiments, if the first CG configuration has resources more than resources of the second CG configuration, the first device 110 may determine that the first CG configuration is used for transmission. In some alternative or additional embodiments, if the first CG configuration is associated with both the first traffic and the second traffic and the second CG configuration is associated with the second traffic, the first device 110 may determine that the first CG configuration is used for transmission.

Continue to refer to FIG. 3, upon determination that the first CG configuration is used for transmission, the first device 110 may deactivate 350 the second CG configuration. In some embodiments, the first device 110 may deactivate the second CG configuration for a duration. In some embodiments, the first device 110 may deactivate the second CG configuration for a set of overlapping occasions between the first and second CG configurations.

Still referring to FIG. 3, in some embodiments where the first CG configuration is associated with the first traffic and the second CG configuration is associated with the second traffic, the first device 110 may further receive 360, from the second device 120, a third CG configuration for the second traffic. The third CG configuration is also associated with the first CG configuration. In some embodiments, the second CG configuration and the third CG configuration may have same time-frequency resource allocation with different demodulation reference signals (DMRS) and medium access control (MAC) configurations. It is to be understood that this is merely an example, and the third CG configuration may be configured independently from the second CG configuration.

With reference to FIG. 3, if the first traffic arrives during the period of time (in which the set of occasions associated with the first CG configuration is to be deactivated), the first device 110 may transmit 370 the second traffic based on the third CG configuration. In some embodiments, upon transmission of the second traffic based on the third CG configuration, the first device 110 may activate 375 the first CG configuration while deactivating the second and third CG configurations.

Upon reception of the second traffic on CG resources of the third CG configuration, the second device 120 may determine 380 that the first CG configuration is activated and the second and third CG configurations are deactivated. The second device 120 may transmit 385, to the first device 110, a hybrid automatic repeat request (HARQ) feedback for the reception of the second traffic. In some embodiments, upon reception of the HARQ feedback, the first device 110 may activate 390 the first CG configuration while deactivating the second and third CG configurations.

For example, the first device 110 is configured with three CG configurations: CG #1 dimensioned for UL video frames, and CG #2 and CG #3 dimensioned for UL pose information. CG #2 is used as a normal CG to carry pose, CG #3 is only used when the first device 110 needs to indicate that a larger grant is needed while still conveying the pose information. In this example, CG #1 has been indicated by the first device 110 to be not used or assumed disabled for N slots (e.g., as UL video frame has been transmitted or UL buffer is below a threshold). The first device 110 is transmitting pose information using CG #2. If during the N slot duration, video frame arrives to the UL buffer, the first device 110 may transmit pose information in CG #3 to indicate the need of activating larger grant. the first device 110 may need to indicate somehow that re-activation of previously de-activated UL video grant is needed. Therefore, the first device 110 may use a special CG #3 to send pose and thus implicitly asking for activation a large video grant CG #1.

This results that both the first device 110 and the second device 120 assume that CG #1 is activated and CG #2 and CG #3 are deactivated (e.g., implicitly). This assumption may be confirmed or applied upon the second device 120 transmitting HARQ feedback for the UL transmission to the first device 110 or via PDCCH based activation indication. In case a CG #1 is deactivated again or over for a time being, then CG #2 may be activated as CG #2 is the primary grant for pose only information. CG #3 is only needed to act as an indication that a larger grant is needed.

So far, the process of communication for CG operation is described. With the process 300, fast re-activation of a CG configuration may be achieved, and communication latency may be reduced.

It is to be noted that the above process 300 is merely an example, and may have additional or less operations. It is also to be noted that operations of the above process 300 may be carried out separately or in any suitable combination.

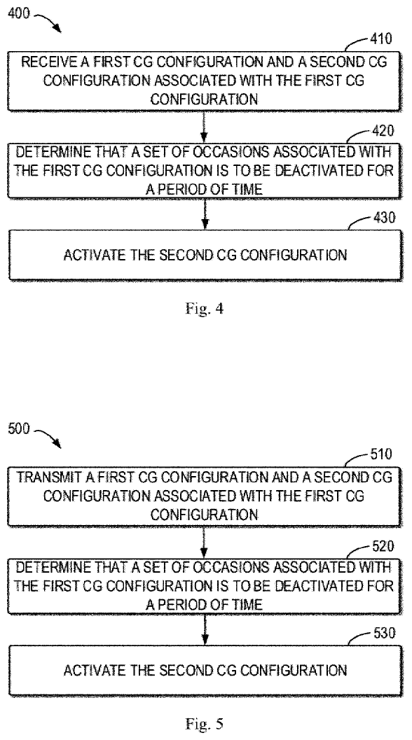

Corresponding to the above process, example embodiments of the present disclosure also provide methods of communication. FIG. 4 illustrates a flowchart of an example method 400 implemented at a first device according to some embodiments of the present disclosure. For the purpose of discussion, the method 400 will be described with reference to FIG. 1.

At block 410, the first device 110 receives, from the second device 120, a first CG configuration and a second CG configuration, the first CG configuration being associated with the second CG configuration.

At block 420, the first device 110 determines that a set of occasions associated with the first CG configuration is to be deactivated for a period of time.

In some embodiments, if no retransmission is scheduled for first traffic associated with the first CG configuration during the period of time, the first device 110 may activate the second CG configuration. In some embodiments, if the first CG configuration is deactivated, the first device 110 may activate the second CG configuration.

In some embodiments, if the first CG configuration overlapping with the second CG configuration is re-activated, the first device 110 may use the first CG configuration for transmission, and deactivate the second CG configuration for the overlapped period of the first and second CG configurations.

In some embodiments, the first CG configuration may be associated with first traffic, and the second CG configuration may be associated with second traffic. In some embodiments, if the first and second CG configurations are overlapped, the first device 110 may determine that the set of occasions carrying the first and second traffic during an overlapped period of the first and second CG configurations is to be deactivated.

In some embodiments, if a size of a buffer associated with the first traffic is below a first threshold size, the first device 110 may determine that the set of occasions associated with the first CG configuration is to be deactivated for the period of time.

In some embodiments, if a buffer status of a logic channel group associated with the first CG configuration in a buffer status report is below a threshold status, the first device 110 may determine that the set of occasions associated with the first CG configuration is to be deactivated for the period of time.

In some embodiments, if a buffer size reported in the buffer status report is above a second threshold size and the first CG configuration corresponds to a data rate lower than a threshold rate, the first device 110 may determine that the set of occasions associated with the first CG configuration is to be deactivated for the period of time.

At block 430, the first device 110 activates the second CG configuration.

In some embodiments, the first device 110 may transmit, to the second device 120, an indication that the set of occasions is to be deactivated for the period of time. In some embodiments, upon transmission of the indication, the first device 110 may activate the second CG configuration.

In some embodiments, the first device 110 may determine that the first CG configuration is used for transmission, and deactivate the second CG configuration for a duration. In some embodiments, the first device 110 may determine that the first CG configuration is used for transmission, and deactivate the second CG configuration for a set of overlapping occasions between the first and second CG configurations.

In some embodiments, if the first CG configuration has a priority higher than a priority of the second CG configuration, the first device 110 may determine that the first CG configuration is used for transmission. In some embodiments, if the first CG configuration has resources more than resources of the second CG configuration, the first device 110 may determine that the first CG configuration is used for transmission. In some embodiments, if the first CG configuration is associated with both first traffic and second traffic and the second CG configuration is associated with the second traffic, the first device 110 may determine that the first CG configuration is used for transmission.

In some embodiments where the first CG configuration may be associated with first traffic, and the second CG configuration may be associated with second traffic, the first device 110 may receive, from the second device 120, a third CG configuration for the second traffic, the third CG configuration being associated with the first CG configuration. If the first traffic arrives during the period of time, the first device 110 may transmit the second traffic based on the third CG configuration. If a HARQ feedback for the transmission of the second traffic based on the third CG configuration is received, or if the second traffic is transmitted based on the third CG configuration, the first device 110 may activate the first CG configuration and deactivate the second and third CG configurations. In some embodiments, the second CG configuration and the third CG configuration may have same time-frequency resource allocation with different demodulation reference signals and medium access control configurations.

With the method 400, a CG configuration may be fast re-activated, and communication latency may be reduced.

FIG. 5 illustrates a flowchart of an example method 500 implemented at a second device according to some embodiments of the present disclosure. For the purpose of discussion, the method 500 will be described with reference to FIG. 1.

At block 510, the second device 120 transmits, to the first device 110, a first CG configuration and a second CG configuration, the first CG configuration being associated with the second CG configuration.

At block 520, the second device 120 determines that a set of occasions associated with the first CG configuration is to be deactivated for a period of time.

In some embodiments, the second device 120 may receive, from the first device 110, an indication that the set of occasions is to be deactivated for the period of time.

In some embodiments, if a buffer status of a logic channel group associated with the first CG configuration in a buffer status report is below a threshold status, the second device 120 may determine that the set of occasions associated with the first CG configuration is to be deactivated for the period of time.

In some embodiments, if a buffer size reported in the buffer status report is above a second threshold size and the first CG configuration corresponds to a data rate lower than a threshold rate, the second device 120 may determine that the set of occasions associated with the first CG configuration is to be deactivated for the period of time.

At block 530, the second device 120 activates the second CG configuration.

In some embodiments, if no retransmission is scheduled for first traffic associated with the first CG configuration during the period of time, the second device 120 may activate the second CG configuration. In some embodiments, if the first CG configuration is deactivated, the second device 120 may activate the second CG configuration.

In some embodiments, if the first CG configuration overlapping with the second CG configuration is re-activated, the second device 120 may use the first CG configuration for transmission, and deactivate the second CG configuration for the overlapped period of the first and second CG configurations.

In some embodiments, the second device 120 may determine that the first CG configuration is used for transmission, and deactivate the second CG configuration for a duration.

In some embodiments, the second device 120 may determine that the first CG configuration is used for transmission, and deactivate the second CG configuration for a set of overlapping occasions between the first and second CG configurations.

In some embodiments, the second device 120 may receive, from the first device 110, an indication that the first CG configuration is used for transmission, the first CG configuration having a priority higher than a priority of the second CG configuration. In some embodiments, the second device 120 may receive, from the first device 110, an indication that the first CG configuration is used for transmission, the first CG configuration having resources more than resources of the second CG configuration. In some embodiments, the second device 120 may receive, from the first device 110, an indication that the first CG configuration is used for transmission, the first CG configuration being associated with both first traffic and second traffic and the second CG configuration being associated with the second traffic.

In some embodiments, the first CG configuration may be associated with first traffic, and the second CG configuration may be associated with second traffic. In some embodiments, the second device 120 may transmit, to the first device 110, a third CG configuration for the second traffic, the third CG configuration being associated with the first CG configuration. In some embodiments, the second CG configuration and the third CG configuration may have same time-frequency resource allocation with different demodulation reference signals and medium access control configurations.

In some embodiments, the second device 120 may receive, from the first device 110 and during the period of time, the second traffic based on the third CG configuration, and determine that the first CG configuration is activated and the second and third CG configurations are deactivated. In some embodiments, the second device 120 may transmit, to the first device 110, a hybrid automatic repeat request feedback for the reception of the second traffic.

With the method 500, fast re-activation of a CG configuration may be facilitated, and communication latency may be reduced.

It is to be noted that the operations of the methods 400 to 500 correspond to that described in connection with FIG. 3, and thus other details are not repeated here for conciseness.

Example embodiments of the present disclosure also provide the corresponding apparatus. In some embodiments, an apparatus (for example, the first device 110) capable of performing the method 400 may comprise means for performing the respective steps of the method 400. The means may be implemented in any suitable form. For example, the means may be implemented in a circuitry or software module.

In some embodiments, the apparatus comprises: means for receiving, from a second device, a first CG configuration and a second CG configuration, the first CG configuration being associated with the second CG configuration; means for determining that a set of occasions associated with the first CG configuration is to be deactivated for a period of time; and means for activating the second CG configuration.

In some embodiments, the apparatus further comprises: means for transmitting, to the second device, an indication that the set of occasions is to be deactivated for the period of time.

In some embodiments, the means for activating the second CG configuration comprises at least one of the following: means for, in accordance with a determination that no retransmission is scheduled for first traffic associated with the first CG configuration during the period of time, activating the second CG configuration; or means for, in accordance with a determination that the first CG configuration is deactivated, activating the second CG configuration.

In some embodiments, the apparatus further comprises: means for, in accordance with a determination that the first CG configuration overlapping with the second CG configuration is re-activated, using the first CG configuration for transmission; and deactivating the second CG configuration for the overlapped period of the first and second CG configurations.

In some embodiments, the apparatus further comprises: means for determining that the first CG configuration is used for transmission; and means for deactivating the second CG configuration for a duration.

In some embodiments, the apparatus further comprises: means for determining that the first CG configuration is used for transmission; and means for deactivating the second CG configuration for a set of overlapping occasions between the first and second CG configurations.

In some embodiments, the means for determining that the first CG configuration is used for transmission comprises at least one of the following: means for, in accordance with a determination that the first CG configuration has a priority higher than a priority of the second CG configuration, determining that the first CG configuration is used for transmission; means for, in accordance with a determination that the first CG configuration has resources more than resources of the second CG configuration, determining that the first CG configuration is used for transmission; or means for, in accordance with a determination that the first CG configuration is associated with both first traffic and second traffic and the second CG configuration is associated with the second traffic, determining that the first CG configuration is used for transmission.

In some embodiments, the first CG configuration is associated with first traffic, and the second CG configuration is associated with second traffic.

In some embodiments, the means for determining that the set of occasions is to be deactivated comprises: means for, in accordance with a determination that the first and second CG configurations are overlapped, determining that the set of occasions carrying the first and second traffic during an overlapped period of the first and second CG configurations is to be deactivated.

In some embodiments, the apparatus further comprises: means for receiving, from the second device, a third CG configuration for the second traffic, the third CG configuration being associated with the first CG configuration; means for, in accordance with a determination that the first traffic arrives during the period of time, transmitting the second traffic based on the third CG configuration; and means for, in accordance with a determination that a hybrid automatic repeat request feedback for the transmission of the second traffic based on the third CG configuration is received, or that the second traffic is transmitted based on the third CG configuration, activating the first CG configuration and deactivating the second and third CG configurations.

In some embodiments, the second CG configuration and the third CG configuration have same time-frequency resource allocation with different demodulation reference signals and medium access control configurations.

In some embodiments, the means for determining that the set of occasions associated with the first CG configuration is to be deactivated for the period of time comprises: means for, in accordance with a determination that a size of a buffer associated with the first traffic is below a first threshold size, determining that the set of occasions associated with the first CG configuration is to be deactivated for the period of time.

In some embodiments, the means for determining that the set of occasions associated with the first CG configuration is to be deactivated for the period of time comprises at least one of the following: means for, in accordance with a determination that a buffer status of a logic channel group associated with the first CG configuration in a buffer status report is below a threshold status, determining that the set of occasions associated with the first CG configuration is to be deactivated for the period of time; or means for, in accordance with a determination that a buffer size reported in the buffer status report is above a second threshold size and the first CG configuration corresponds to a data rate lower than a threshold rate, determining that the set of occasions associated with the first CG configuration is to be deactivated for the period of time.

In some embodiments, an apparatus (for example, the second device 120) capable of performing the method 500 may comprise means for performing the respective steps of the method 500. The means may be implemented in any suitable form. For example, the means may be implemented in a circuitry or software module.

In some embodiments, the apparatus comprises: means for transmitting, to a first device, a first CG configuration and a second CG configuration, the first CG configuration being associated with the second CG configuration; means for determining that a set of occasions associated with the first CG configuration is to be deactivated for a period of time; and means for activating the second CG configuration.

In some embodiments, the means for determining that the set of occasions associated with the first CG configuration is to be deactivated for the period of time comprises: means for receiving, from the first device, an indication that the set of occasions is to be deactivated for the period of time.

In some embodiments, the means for activating the second CG configuration comprises at least one of the following: means for, in accordance with a determination that no retransmission is scheduled for first traffic associated with the first CG configuration during the period of time, activating the second CG configuration; or means for, in accordance with a determination that the first CG configuration is deactivated, activating the second CG configuration.

In some embodiments, the apparatus further comprises: means for, in accordance with a determination that the first CG configuration overlapping with the second CG configuration is re-activated, using the first CG configuration for transmission and deactivating the second CG configuration for the overlapped period of the first and second CG configurations.

In some embodiments, the apparatus further comprises: means for determining that the first CG configuration is used for transmission; and means for deactivating the second CG configuration for a duration.

In some embodiments, the apparatus further comprises: means for determining that the first CG configuration is used for transmission; and means for deactivating the second CG configuration for a set of overlapping occasions between the first and second CG configurations.

In some embodiments, the means for determining that the first CG configuration is used for transmission comprises at least one of the following: means for receiving, from the first device, an indication that the first CG configuration is used for transmission, the first CG configuration having a priority higher than a priority of the second CG configuration; means for receiving, from the first device, an indication that the first CG configuration is used for transmission, the first CG configuration having resources more than resources of the second CG configuration; or means for receiving, from the first device, an indication that the first CG configuration is used for transmission, the first CG configuration being associated with both first traffic and second traffic and the second CG configuration being associated with the second traffic.

In some embodiments, the first CG configuration is associated with first traffic, and the second CG configuration is associated with second traffic.

In some embodiments, the apparatus further comprises at least one of the following: means for transmitting, to the first device, a third CG configuration for the second traffic, the third CG configuration being associated with the first CG configuration; means for receiving, from the first device and during the period of time, the second traffic based on the third CG configuration; means for determining that the first CG configuration is activated and the second and third CG configurations are deactivated; or means for transmitting, to the first device, a hybrid automatic repeat request feedback for the reception of the second traffic.

In some embodiments, the second CG configuration and the third CG configuration have same time-frequency resource allocation with different demodulation reference signals and medium access control configurations.

In some embodiments, the means for determining that the set of occasions associated with the first CG configuration is to be deactivated for the period of time comprises: means for, in accordance with a determination that a buffer status of a logic channel group associated with the first CG configuration in a buffer status report is below a threshold status, determining that the set of occasions associated with the first CG configuration is to be deactivated for the period of time; or means for, in accordance with a determination that a buffer size reported in the buffer status report is above a second threshold size and the first CG configuration corresponds to a data rate lower than a threshold rate, determining that the set of occasions associated with the first CG configuration is to be deactivated for the period of time.

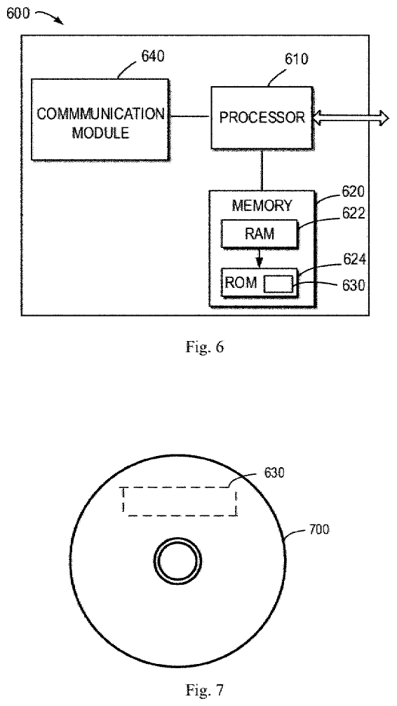

FIG. 6 is a simplified block diagram of a device 600 that is suitable for implementing embodiments of the present disclosure. The device 600 may be provided to implement the communication device, for example the first device 110 or the second device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 620. The processor 610 may perform any suitable actions and processing by loading the program 630 into the RAM 620.

The embodiments of the present disclosure may be implemented by means of the program 630 so that the device 600 may perform any process of the disclosure as discussed with reference to FIGS. 1 to 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 500 as described above with reference to FIGS. 4 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device at least to:
receive, from a second device, a first configured grant configuration and a second configured grant configuration, the first configured grant configuration being associated with the second configured grant configuration;
determine that a set of occasions associated with the first configured grant configuration is to be deactivated for a period of time; and
activate the second configured grant configuration.

2. The first device of claim 1, wherein the first device is further caused to:
transmit, to the second device, an indication that the set of occasions is to be deactivated for the period of time.

3. The first device of claim 1, wherein the first device is caused to activate the second configured grant configuration by at least one of the following:
in accordance with a determination that no retransmission is scheduled for first traffic associated with the first configured grant configuration during the period of time, activating the second configured grant configuration; or
in accordance with a determination that the first configured grant configuration is deactivated, activating the second configured grant configuration.

4. The first device of claim 3, wherein the first device is further caused to:
in accordance with a determination that the first configured grant configuration overlapping with the second configured grant configuration is re-activated,
use the first configured grant configuration for transmission; and
deactivate the second configured grant configuration for the overlapped period of the first and second configured grant configurations.

5. The first device of claim 1, wherein the first device is further caused to:
determine that the first configured grant configuration is used for transmission; and
deactivate the second configured grant configuration for a duration.

6. The first device of claim 1, wherein the first device is further caused to:
determine that the first configured grant configuration is used for transmission; and
deactivate the second configured grant configuration for a set of overlapping occasions between the first and second configured grant configurations.

7. The first device of claim 5, wherein the first device is caused to determine that the first configured grant configuration is used for transmission by at least one of the following:
in accordance with a determination that the first configured grant configuration has a priority higher than a priority of the second configured grant configuration, determining that the first configured grant configuration is used for transmission;
in accordance with a determination that the first configured grant configuration has resources more than resources of the second configured grant configuration, determining that the first configured grant configuration is used for transmission; or
in accordance with a determination that the first configured grant configuration is associated with both first traffic and second traffic and the second configured grant configuration is associated with the second traffic, determining that the first configured grant configuration is used for transmission.

8. The first device of claim 1, wherein the first configured grant configuration is associated with first traffic, and the second configured grant configuration is associated with second traffic.

9. The first device of claim 8, wherein the first device is caused to determine that the set of occasions is to be deactivated by:
in accordance with a determination that the first and second configured grant configurations are overlapped, determining that the set of occasions carrying the first and second traffic during an overlapped period of the first and second configured grant configurations is to be deactivated.

10. The first device of claim 8, wherein the first device is further caused to:
receive, from the second device, a third configured grant configuration for the second traffic, the third configured grant configuration being associated with the first configured grant configuration;
in accordance with a determination that the first traffic arrives during the period of time, transmit the second traffic based on the third configured grant configuration; and
in accordance with a determination that a hybrid automatic repeat request feedback for the transmission of the second traffic based on the third configured grant configuration is received, or that the second traffic is transmitted based on the third configured grant configuration,
activate the first configured grant configuration; and
deactivate the second and third configured grant configurations.

11. The first device of claim 10, wherein the second configured grant configuration and the third configured grant configuration have same time-frequency resource allocation with different demodulation reference signals and medium access control configurations.

12. The first device of claim 8, wherein the first device is caused to determine that the set of occasions associated with the first configured grant configuration is to be deactivated for the period of time by:
in accordance with a determination that a size of a buffer associated with the first traffic is below a first threshold size, determining that the set of occasions associated with the first configured grant configuration is to be deactivated for the period of time.

13. The first device of claim 1, wherein the first device is caused to determine that the set of occasions associated with the first configured grant configuration is to be deactivated for the period of time by at least one of the following:
in accordance with a determination that a buffer status of a logic channel group associated with the first configured grant configuration in a buffer status report is below a threshold status, determining that the set of occasions associated with the first configured grant configuration is to be deactivated for the period of time; or
in accordance with a determination that a buffer size reported in the buffer status report is above a second threshold size and the first configured grant configuration corresponds to a data rate lower than a threshold rate, determining that the set of occasions associated with the first configured grant configuration is to be deactivated for the period of time.

14. A second device comprising:
at least one processor; and
at least one memory storing instructions that, when executed by the at least one processor, cause the second device at least to:
transmit, to a first device, a first configured grant configuration and a second configured grant configuration, the first configured grant configuration being associated with the second configured grant configuration;
determine that a set of occasions associated with the first configured grant configuration is to be deactivated for a period of time; and
activate the second configured grant configuration.

15. The second device of claim 14, wherein the second device is caused to determine that the set of occasions associated with the first configured grant configuration is to be deactivated for the period of time by:
receiving, from the first device, an indication that the set of occasions is to be deactivated for the period of time.

16. The second device of claim 14, wherein the second device is caused to activate the second configured grant configuration by at least one of the following:
in accordance with a determination that no retransmission is scheduled for first traffic associated with the first configured grant configuration during the period of time, activating the second configured grant configuration; or
in accordance with a determination that the first configured grant configuration is deactivated, activating the second configured grant configuration.

17. The second device of claim 16, wherein the second device is further caused to:
in accordance with a determination that the first configured grant configuration overlapping with the second configured grant configuration is re-activated,
use the first configured grant configuration for transmission; and
deactivate the second configured grant configuration for the overlapped period of the first and second configured grant configurations.

18. The second device of claim 14, wherein the second device is further caused to:
determine that the first configured grant configuration is used for transmission; and
deactivate the second configured grant configuration for a duration.

19. The second device of claim 14, wherein the second device is further caused to:
determine that the first configured grant configuration is used for transmission; and
deactivate the second configured grant configuration for a set of overlapping occasions between the first and second configured grant configurations.

20.-24. (canceled)

25. A method of communication comprising:
receiving, at a first device and from a second device, a first configured grant configuration and a second configured grant configuration, the first configured grant configuration being associated with the second configured grant configuration;
determining that a set of occasions associated with the first configured grant configuration is to be deactivated for a period of time; and
activating the second configured grant configuration.

26.-29. (canceled)
